(19) United States
(12) Patent Application Publication
(10) Pub. No.: US 2025/0049009 A1
(43) Pub. Date: Feb. 13, 2025

(54) DIVE COMPUTER FOR FISH CALL

(71) Applicant: MIKROPIX ELEKTRIK ELEKTRONIK SANAYI VE TICARET LIMITED SIRKETI, Istanbul (TR)

(72) Inventors: Erdem PAMUK, Istanbul (TR); Murat UNAL, Istanbul (TR)

(73) Assignee: MIKROPIX ELEKTRIK ELEKTRONIK SANAYI VE TICARET LIMITED SIRKETI, Istanbul (TR)

(21) Appl. No.: 18/719,835

(22) PCT Filed: Oct. 24, 2022
(86) PCT No.: PCT/TR2022/051174

§ 371 Date: Jun. 14, 2024

(30) Foreign Application Priority Data
Dec. 31, 2021 (TR) 2021/022249

(51) Int. Cl. A01K 81/06; G05B 15/02

(52) U.S. Cl. CPC A01K 81/06; G05B 15/02

(57) ABSTRACT

A dive computer includes a pressure sensor, a screen, and a processor unit configured to control the screen and receive pressure measurements from the pressure sensor. The dive computer further includes a call member that performs at least one of the processes of emitting sound waves, emitting light, or generating vibration to call fish when operated, and the processor unit is configured to operate the call member when the processor unit detects that a predetermined trigger condition is met.

### CROSS REFERENCE TO THE RELATED APPLICATIONS

This application is the national phase entry of International Application No. PCT/TR2022/051174, filed on Oct. 24, 2022, which is based upon and claims priority to Turkish Patent Application No. 2021/022249, filed on Dec. 31, 2021, the entire contents of which are incorporated herein by reference.

### TECHNICAL FIELD

The invention relates to the wearable dive computer. In particular, the invention relates to the dive computer where the underwater diving person can follow the diving information underwater.

### BACKGROUND

Dive computers are devices developed for free diving, scuba diving, and spearfishing.

Dive computers in scuba diving are devices that help the diver to dive safely and get up on the water safely without getting decompression disease (nitrogen necrosis). The system and devices for monitoring the information such as the time spent underwater, the distance to the diving point and the water surface, the pressure exposed, the oxygen tube pressure and the amount of oxygen remaining are available in the relevant art. The US patent application US20060369470 refers to a dive computer with a screen that shows the time spent by the diver at certain depths and the pressure they are exposed to prevent underwater diving people from being exposed to the nitrogen necrosis event. It may also indicate whether it is safe to surface without a decompression stop from the screen of the dive computer in the aforementioned application and, if not, the proposed decompression program or protocol, the recommended stop depth/depths, and stopping time at each stopping depth.

Free diving and spearfishing dive computers are devices that keep records for each dive, such as diving time (breath time held), depth information, water temperature, and the number of dives.

Hunters who are interested in fishing underwater develop different methods to attract and not spook the fish during their time underwater. For example, to prevent fish from spooking and escaping, to ensure that they move quite slowly underwater, and to lie still on the ground to fish, some of the techniques applied by underwater fishermen are among the techniques.

One of the most important elements in underwater fishing is to attract the fish to get closer to the hunter and to increase hunting efficiency. The technique known and most widely used to attract fish underwater is the stealth technique. With the stealth technique, the hunter reaches the sea floor with very calm movements, conceals themselves with the natural environment, and tries to bring the fish closer by holding their breath for as long as possible. In these and similar hunting techniques, hunters use various fish calling methods to guide the fish toward them. Fish calling methods are techniques developed according to the principle of benefiting from the fact that fish are curious animals. Some of these are making a sound from the throat, hitting the harpoon grip to the stone, making a friction sound with gloves, moving an object that can reflect light, making light movements with a lantern, making a sound using mechanical fish calling tools, and similar methods.

These practices may cause the fish to lose their focus on the target by creating an extra workload for the underwater fisherman, to be unable to use their breath efficiently, and to scare away the fish due to the movements of the underwater fisherman.

All the problems mentioned above have made it necessary to make an innovation in the relevant technical field as a result.

### BRIEF DESCRIPTION OF THE INVENTION

The present invention relates to the underwater dive computer to eliminate the above-mentioned disadvantages and to bring new advantages to the related technical field.

It is an object of the invention to provide the dive computer to allow the user to call fish underwater.

Another object of the invention is to increase the freedom of movement while enabling the user to call fish underwater.

Another object of the invention is to provide the dive computer that can be configured to call fish according to different fish species.

Another object of the invention is to provide the dive computer to monitor the diving information of underwater diving people.

Another object of the invention is to ensure that the diver does not have to carry mechanical sounders, lanterns, stones, and similar tools to call fish and to ensure a more comfortable dive.

In order to achieve all the objectives that are mentioned above and will emerge from the following detailed description, the present invention is the dive computer including a pressure sensor, a screen, and a processor unit configured to control the said screen and receive pressure measurements from the said pressure sensor. Accordingly, its novelty is that it includes a call member performing at least one of the processes of emitting sound waves, emitting light, or generating vibration to call fish when operated; characterized in that the processor unit is configured to operate the call member when it detects that a predetermined trigger condition is met. Thus, while the diver checks their diving information, they also attract the fish and call them.

A possible embodiment of the invention is characterized in that the said call member includes an audio call member for emitting a sound wave. In this way, the dive computer is provided to emit sound for calling fish.

Another possible embodiment of the invention is characterized in that the said audio call member is a buzzer.

Another possible embodiment of the invention is characterized in that the said call member includes a vibration call member. Thus, the dive computer can generate vibration to call fish. It is recognized that the hearing function of many fish is possible when some bone structures in their heads detect vibrations in the water. It is aimed that the vibration call member emits vibration in the water and stimulates the sensory organ of the fish.

Another possible embodiment of the invention is characterized in that the said vibration call member is a vibration motor.

Another possible embodiment of the invention is characterized in that the said call member includes a light call member. Thus, the dive computer can emit light to call fish. It is known that many species of predatory fish have an interest in shining bodies and creatures. It is aimed to stimulate this interest with the light call member.

Another possible embodiment of the invention is characterized in that the said light call member is the said screen.

Another possible embodiment of the invention is characterized in that it includes an input unit to allow the user to send commands to the processor unit; the said trigger condition is a predetermined input command received from the input unit. Thus, by providing the trigger condition, the command is sent to the processor unit and the call member is operated.

Another possible embodiment of the invention is characterized in that the said trigger condition exceeds a predetermined threshold value of the pressure measurement taken from the pressure sensor. Thus, when a certain depth level is reached, the call member is operated.

Another possible embodiment of the invention is characterized in that it includes an acceleration sensor associated with the processor unit to send the measurements it receives to the processor unit; the said trigger condition is that the measurements taken from the acceleration sensor meet the predetermined conditions. Thus, the call member is operated by providing the sensed trigger condition with the acceleration sensor.

Another possible embodiment of the invention is characterized in that it includes an input unit that allows the user to send a command to the processor unit, it includes an acceleration sensor associated with the processor unit to send the measurements it receives to the processor unit, the said trigger condition is a predetermined input command received from the input unit, the pressure measurement received from the pressure sensor exceeds a predetermined threshold value and the measurements taken from the acceleration sensor meet the predetermined conditions. Thus, it is ensured that the call member is operated by providing any trigger condition.

Another possible embodiment of the invention is characterized in that it includes a connection member for securing the dive computer to the user. Thus, the dive computer is wearable.

Another possible embodiment of the invention is characterized in that the said connection member is in the form of a watch strap or wristband. Thus, the dive computer can be plugged in and removed.

### BRIEF DESCRIPTION OF THE FIGURES

FIG. 1A shows the top perspective view of the dive computer.

FIG. 1B shows a representative cross-sectional view of the dive computer.

FIG. 1C shows a representative cross-sectional view of the dive computer.

FIG. 1D shows a representative cross-sectional view of the dive computer from the right.

FIG. 2A shows a representative view of the block diagram of the dive computer.

FIG. 2B shows a representative view of the block diagram of the call member.

### REFERENCE NUMBERS GIVEN IN THE FIGURES

100 Dive computer
110 Processor unit
120 Memory unit
130 Screen
140 Input unit
150 Call member
   151 Audio call member
   152 Vibration call member
   153 Light call member
160 Acceleration sensor
170 Charging interface
   171 Battery
180 Pressure sensor
   181 Water inlet opening
190 Body
195 Connection member
260 Communication unit
210 Counter
300 Mobile device

### DETAILED DESCRIPTION OF THE EMBODIMENTS

In this detailed description, the dive computer (100) of the invention is explained with examples that do not have any limiting effect only for a better understanding of the subject.

The invention is essentially the dive computer (100) that includes a call member (150) for the user to follow the diving information underwater and also to enable the user to call fish. The said user refers to underwater photographers, underwater researchers, scuba underwater divers, underwater fishing divers, and similar persons using underwater dive computers (100).

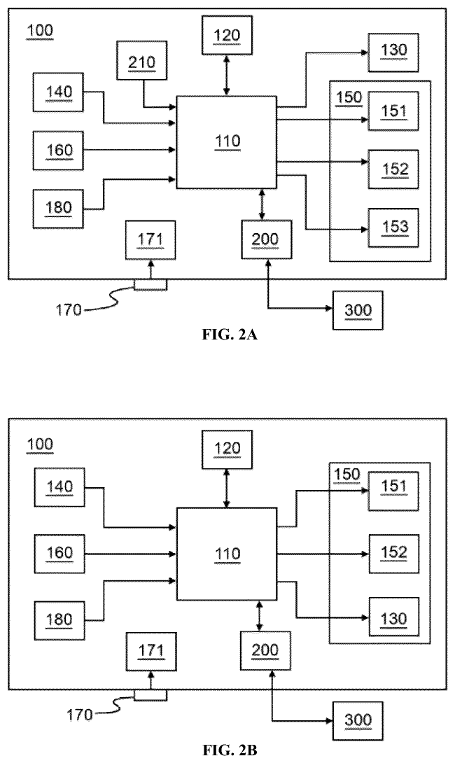

Referring to FIGS. 2A-2B, the present invention relates to the dive computer (100) including a screen (130) on which the user can monitor diving information, at least one pressure sensor (180) to measure pressure underwater, a processor unit (110) configured to receive information from the said pressure sensor (180) and to control the said screen (130), and a call member (150) to enable the user to call fish.

The dive computer (100) includes at least one call member (150) for calling fish underwater. The said call member (150) performs at least one of the processes of emitting sound waves, emitting light, or generating vibration to call fish. The processor unit (110) is configured to operate the call member (150) when it detects that a predetermined trigger condition is met.

The dive computer (100) also includes a memory unit (120). The processor unit (110) is associated with the memory unit (120) to read and write data. The memory unit (120) may include functional software modules consisting of command lines that enable the operation steps that contribute to the operation of the invention when executed by the processor unit (110).

According to the possible embodiment of the invention, the dive computer (100) includes at least one input unit (140) for the user to send commands to the processor unit (110). The input unit (140) may include button-like input members. The input members send an input signal to the processor unit (110) when they are activated. In a possible embodiment of the invention, the trigger condition is a predetermined input signal received from the input unit (140). The processor unit (110) operates the call member (150) when it receives a predetermined input signal from the input unit (140). Thus, the user can ensure that the trigger condition is met by using the input unit (140). In the preferred embodiment, the input unit (140) includes four buttons as input members. The said input members allow controlling various functions of the dive computer (100). According to an exemplary embodiment, a button contained in the input unit (140) refers to the input signals that enable the initiation and termination of the dive time; the display of dive information such as another button depth and pressure on the screen (130); the fulfillment of another button trigger condition; and the examination of dive information in another button memory unit (120). In a possible embodiment of the invention, the said input signal may be a signal sent to the processor unit (110) when a predetermined input member/button is pressed. In another possible embodiment of the invention, the input signal can be the signals sent to the processor unit (110) obtained by pressing more than one button at the same time, pressing certain buttons sequentially, and pressing a button for a predetermined period.

According to a possible embodiment of the invention, the said trigger condition is that the pressure measurement from the pressure sensor (180) has exceeded a predetermined threshold value. Thus, it is ensured that the trigger condition is met when a certain pressure level or depth is reached. Thus, the call member (150) is operated by the processor unit (110).

In another possible embodiment of the invention, the dive computer (100) includes an acceleration sensor (160) associated with the processor unit (110) to send the measurements it receives to the processor unit (110). In this embodiment, the trigger condition is that the values taken from the acceleration sensor (160) meet the predetermined criteria. The said acceleration sensor (160) generates a signal according to the movements of the dive computer (100). The processor unit (110) determines the movement of the user according to the signals it receives from the acceleration sensor (160). The motion detection from the acceleration sensor (160) is not detailed here as it is known in the art. For example, the detection of movements such as wrist rotation and wrist waving using the acceleration sensor (160) is known in the art. The processor unit (110) determines the type of movement according to the pattern of successive signals it receives from the acceleration sensor (160). Thus, it is ensured that the trigger condition is met by the user moving the dive computer (100) in a predetermined way. For example, it can be ensured that the trigger condition is met by the user performing the wrist twist movement of the dive computer (100) positioned on the wrist of the user clockwise or counterclockwise. In an alternative embodiment, the processor unit (110) can detect that the user is shaking the dive computer (100) with wrist movement according to the signals received from the acceleration sensor (160) and this detection can ensure that the trigger condition is met. In another alternative embodiment, the trigger condition can be met by the user moving the dive computer (100) back and forth. Likewise, it can end the fulfillment of the trigger condition by the user repeating the said movements or doing the opposite of the said movements. Thus, the operation of the call member (150) is stopped by the processor unit (110).

In a possible embodiment of the invention, the dive computer (100) includes a counter (210). The said counter (210) is associated with the processor unit (110). In the preferred embodiment, referring to FIG. 2B, the said counter (210) is the software code executed on the processor unit (110). In this embodiment, the provision of the trigger condition is the counting of a certain trigger time by the counter (210). When a certain triggering time is counted by the counter (210), the processor unit (110) operates the call member (150). The operation of the said counter (210) may be configured by the user with the input unit (140). For example, by pressing a button, the operation of the counter (210) or operation after a certain period can be started. Another example is that according to the information received from the pressure sensor (180), the operation of the counter (210) can be started. In this example, by counting the triggering time when a certain depth is reached, the processor unit (110) is enabled to operate the call member (150). Thus, the call member (150) is operated without the diver having to make any extra movement.

In a possible embodiment of the invention, the dive computer (100) includes a communication unit (200) associated with the processor unit (110). The said communication unit (200) enables the dive computer (100) to be controlled by a mobile device (300). The said mobile device (300) can be devices such as computers, tablets, and phones. In a possible embodiment of the invention, the mobile device (300) has an application configured to control the dive computer (100). The dive computer (100) can be controlled through the communication unit (200) through the said application with the said mobile device (300). The said application also enables the storage of dive data, sending it to cloud applications, easy configuration of users, customization of the dive computer (100) by the users, customization of the fish call parameters, downloading and updating of the processor unit (110) software from a server.

In a possible embodiment of the invention, the trigger condition may be dependent on one or more conditions. The trigger condition can be met if a predetermined pressure level or calculated depth is reached, the acceleration sensor (160) detects a certain movement, a specified button is pressed, or a certain trigger time is provided. The user can adjust the fulfillment of the trigger condition by providing one of the said conditions or binary combinations or all three or all of them together. The user may select the trigger conditions in the memory unit (120) via the input unit (140) or the mobile device (300). Likewise, the trigger conditions in the memory unit (120) can be configured using the input unit (140) or the mobile device (300). According to an exemplary embodiment, the trigger condition is met if the dive computer (100) reaches a certain depth and the user performs the wrist twist movement. Thus, it is ensured that the user performs the fish calling process without having to use their hand, where they hold any tools such as a harpoon. In addition, the operation of the call member (150) is prevented without reaching a certain depth or diving underwater. Alternatively, when both buttons are pressed or the dive computer (100) is moved back and forth, it is ensured that the fish call process is carried out before a certain depth is reached. The user can set the call operation to repeat one or more times. It may be desired to stop or restart the call process before the number of times the call process is completed. The stop and restart commands created for this can be provided by the input unit (140), the acceleration sensor (160), the pressure sensor (180), or the counter (210). The stop and restart commands may be configured by the user via the input unit (140) or the mobile device (300). For example, if the user has configured the stop-restart command in the event of a predetermined movement or immobility being detected from the acceleration sensor (160), the operation of the call operation is stopped by providing the said movement while the call operation takes place. The aim here is to prevent the spooking of a fish that is afraid of the fish calling process and to create a silent environment. After the silent environment, the operation of the call-up process is restarted by providing the movement again to draw the attention of the distracted fish. As another example; if the user has previously configured the stop-restart command with the button when the button (140) is pressed, the operation of the call operation is stopped. When the button (140) is pressed again, the operation of the call operation is restarted.

In a possible embodiment of the invention, the call member (150) includes an audio call member (151) for emitting sound waves. The said audio call member (151) is configured to emit a sound wave to attract the fish. In a preferred embodiment, a buzzer is used as the audio call member (151). In another possible embodiment of the invention, a speaker can be used as the audio call member (151). The user can adjust the frequency and amplitude of the sound wave to be emitted by the audio call member (151) via the input unit (140) or the mobile device (300). Thus, the audio call member (151) may be configured according to the type of fish desired to be hunted by the user.

In a possible embodiment of the invention, the call member (150) includes a vibration call member (152) for generating vibration. The said vibration call member (152) is configured to generate a vibration to attract the fish. In a preferred embodiment, a vibratory motor is used as the vibration call member (152). The user can adjust the frequency and intensity of the vibration to be generated by the vibration call member (152) via the input unit (140) or the mobile device (300). Thus, the vibration call member (152) may be configured according to the type of fish desired to be hunted by the user. The said vibrating vibration motor uses vibration waves to the water, vibrating the dive computer (100) during the operator-configured operating time. It is recognized that the hearing function of many fish is possible when some bone structures in their heads detect vibrations in the water. The vibration call member (152) is intended to emit a vibration in the water and to stimulate the sensory organ of the fish.

In a possible embodiment of the invention, the call member (150) includes a light call member (153) for emitting light. The said light call member (153) is configured to emit light to attract the fish. In a preferred embodiment, the screen (130) is used as the light call member (153). Alternatively, any light source may be used as the light call member (153). The said light source may be located anywhere on the dive computer (100). The user can adjust the input unit (140) or the wavelength, intensity, intensity, and frequency of the light emitted by the light call member (153) through the mobile device (300). Thus, the light call member (153) can be configured according to the type of fish desired to be hunted by the user. The said screen (130) generates light at the wavelength (light color) configured by the user during the user-configured operating time. Thus, it is ensured that the dive computer (100) emits light in a way to call the fish. It is known that many fish species have an interest in shining bodies and creatures. It is aimed to stimulate this interest with the light call member (153).

In a possible embodiment of the invention, the call member (150) includes the audio call member (151), the vibration call member (152), and the light call member (153). The said audio call member (151), the vibration call member (152) and the light call member (153) may be selectively operated. The user can select the call member (150) that they want to operate through the input unit (140) or the mobile device (300). For example, by meeting the trigger condition at certain depth ranges, the operation of the call member (150) operates the audio call member (151). By meeting the trigger condition in another depth range, the actuation of the call member (150) enables the vibration call member (152) and the light call member (153) to be actuated together. The user can select the trigger condition or conditions through the input unit (140) or the mobile device (300) and which call member (150) is to be operated under which trigger condition.

In a possible embodiment of the invention, the memory unit (120) includes predetermined variations of the trigger conditions and the operating conditions of the audio call member (151), the vibration call member (152), and the light call member (153). The user can select or modify the variations by commanding the processor unit (110) via the input unit (140) or the mobile device (300). In a possible embodiment of the invention, the memory unit (120) enables the storage of the dive information processed in the processor unit (110). The user may examine the information stored in the memory unit (120) via the input unit (140) or the mobile device (300). The said dive information may include information such as dive date, dive time, depth, location, water temperature, and the dive duration.

In a possible embodiment of the invention, the processor unit (110) receives the pressure information that the user is exposed to underwater from the pressure sensor (180) and reflects it to the screen (130). The user can follow the pressure information that the dive computer (100) is exposed to by means of the screen (130) while diving underwater. At the same time, the underwater pressure information received from the pressure sensor (180) is processed by the processor unit (110) and the depth (distance to the water surface) of the user is calculated. The calculated depth is reflected on the screen (130) and the user is informed. Moreover, the change in the value taken from the pressure sensor (180) at the time of the first dive into the water can be detected by the processor unit (110) and the dive time can be started. According to a possible embodiment of the invention, when the value measured by the pressure sensor (180) reaches a certain level, the processor unit (110) is configured to give a warning on the screen (130). In this way, it is prevented that the user is exposed to the nitrogen narcosis event.

In a possible embodiment of the invention, the processor unit (110) may be configured to give an audible and/or vibrating and/or illuminated warning when the depth determined by the user is exceeded. The user can select or modify the variations by commanding the processor unit (110) via the input unit (140) or the mobile device (300). The said depth information is determined according to the information received from the pressure sensor (180) of the processor unit (110). Thus, it is ensured that the user is warned when a predetermined depth level (pressure level) is reached.

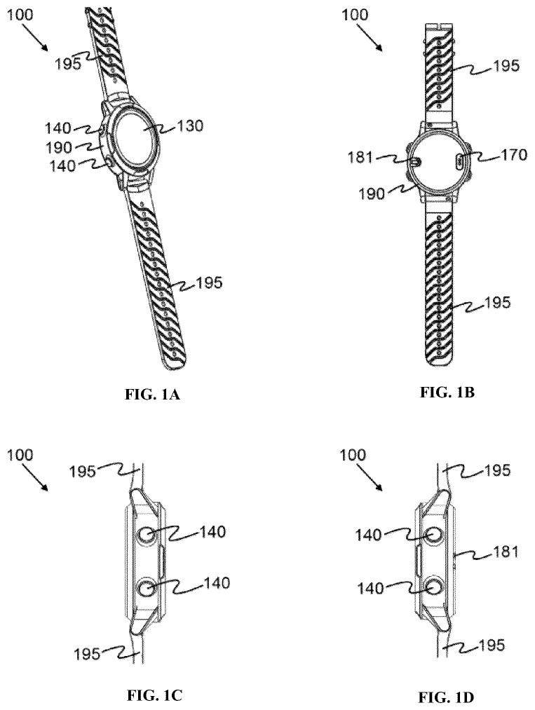

The dive computer (100), referring to FIGS. 1A-1D, includes a body (190). The components of the dive computer (100) are positioned on the body (190). The body (190) has a sealing feature that prevents the components of the dive computer (100) from receiving water. In the preferred embodiment of the invention, the body (190) includes a water inlet opening (181) that will allow it to contact the water to measure the pressure under the water of the said pressure sensor (180). The pressure of the water entering through the water inlet opening (181) is measured by the pressure sensor (180). The dive computer (100) further includes a connection member (195). The said connection member (195) allows the user to wear the dive computer (100). According to a possible embodiment of the invention, the connection member (195) is provided in the form of a wristwatch strap or wristband. The connection member (195) may preferably be selected from water-resistant materials such as leather, rubber, or plastic.

In the preferred embodiment of the invention, the said screen (130) has been selected to have a high resolution so that it can be easily seen by the user underwater or outside. According to the preferred embodiment, the screen (130) is an AMOLED screen.

The dive computer (100), referring to FIGS. 2A-2B, includes a battery (171). The said battery (171) provides the energy required for the operation of the dive computer (100). The dive computer (100) has a charging interface (170) for charging the battery (171). The battery (171) that supplies energy to the dive computer (100) is charged by the said charging interface (170).

In a possible embodiment of the invention, the dive computer (100) may be configured for the scuba dive. In this embodiment, the call member (150) can be used for monitoring, investigating, photographing, and the like.

In a possible embodiment of the invention, the dive computer (100) may be configured for free diving. In this embodiment, the call member (150) can be used for monitoring, investigating, photographing, and the like.

In a possible embodiment of the invention, the dive computer (100) may be configured for spearfishing. In this embodiment, the call member (150) may be used to fish.

In a possible embodiment of the invention, the dive computer (100) may include all, only one, or desired combinations of scuba, free diving, and spearfishing. The fish recall functions to operate with these combinations may be a single fish recall function or may be customized according to the combinations, with different parameters added or omitted.

In an exemplary operating scenario of the invention; the diver attaches the dive computer (100) to his wrist with the connection member (195). The dive time is started when the user enters the water and the change in the value taken from the pressure sensor (180) is detected by the processor unit (110) or when the user presses a button. The pressure sensor (180) continuously measures the pressure underwater and sends it to the processor unit (110). The depth of the user is continuously calculated by processing in the information processor unit (110) received from the pressure sensor (180). The processor unit (110) reflects information such as the dive time, the pressure exposed, and the depth level on the screen (130). When the user wants to call a fish to fish, it meets the predetermined trigger condition. When the trigger condition is met, the predetermined call member (150) is operated. The operation of the call member (150) attracts the attention of the fish and ensures that the fish are directed towards the user. Thus, it is easier for the user to fish with the harpoon and the possibility of missing the target is reduced. After completing the dive, the user moves to the water surface. The user who starts the movement to the water surface follows the pressure and depth information on the screen (130). The dive computer (100) warns the user of certain pressure changes to prevent nitrogen necrosis during underwater diving and climbing to the water surface. When the user reaches the water surface and the change in the value taken from the pressure sensor (180) is detected by the processor unit (110) or when the user presses a button, the dive time is terminated. All dive information between the start of the dive time and the end of the dive time is stored in the memory unit (120). The user can examine the information stored in the memory unit (120) at any time via the input unit (140) or via the application with the mobile device (300).

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

What is claimed is:

1. A dive computer, comprising:
a pressure sensor,
a screen,
a processor unit, wherein the processor unit is configured to control the screen and receive a pressure measurement from the pressure sensor, and
a call member, wherein the call member is configured to perform at least one of processes of emitting a sound wave, emitting light or generating vibration to call fish when operated;
wherein the processor unit is configured to operate the call member when the processor unit detects that a predetermined trigger condition is met.

2. The dive computer according to claim 1, wherein the call member comprises an audio call member to emit the sound wave.

3. The dive computer according to claim 2, wherein the audio call member is a buzzer or speaker.

4. The dive computer according to claim 1, wherein the call member comprises a vibration call member.

5. The dive computer according to claim 4, wherein the vibration call member is a vibration motor.

6. The dive computer according to claim 1, wherein the call member comprises a light call member.

7. The dive computer according to claim 6, wherein the light call member is the screen.

8. The dive computer according to claim 1, further comprising an input unit, wherein the input unit is configured to allow a user to send commands to the processor unit, and the predetermined trigger condition is a predetermined input signal received from the input unit.

9. The dive computer according to claim 1, wherein the pressure measurement taken from the pressure sensor of the predetermined trigger condition has exceeded a predetermined threshold value.

10. The dive computer according to claim 1, further comprising an acceleration sensor associated with the processor unit, wherein the acceleration sensor is configured to send received measurements to the processor unit; and the predetermined trigger condition is that the received measurements taken from the acceleration sensor meet predetermined conditions.

11. The dive computer according to claim 1, further comprising a counter associated with the processor unit, wherein the counter is configured to count a certain time; and the predetermined trigger condition is that the counter counts a predetermined trigger time.

12. The dive computer according to claim 1, further comprising:
an input unit, wherein the input unit is configured to allow a user to send a command to the processor unit; and
an acceleration sensor associated with the processor unit, wherein the acceleration sensor is configured to send received measurements to the processor unit;
wherein the predetermined trigger condition is a predetermined input command received from the input unit; and the pressure measurement taken from the pressure sensor exceeds a predetermined threshold value, and the received measurements taken from the acceleration sensor meet predetermined conditions.

13. The dive computer according to claim 1, further comprising a communication unit, wherein the communication unit is configured to allow the processor unit to communicate with a mobile device.

14. The dive computer according to claim 1, further comprising a connection member for fixing the dive computer to a user.

15. The dive computer according to claim 14, wherein the connection member is in a form of a watch strap or wristband.
